(19) United States
(12) Patent Application Publication
(10) Pub. No.: US 2003/0085128 A1
(43) Pub. Date: May 8, 2003

(54) Flexible and physically conformable apparatus for removing particulate matter from non-conductive fluids

(76) Inventor: Luigi John Toffolo, Wilton, CT (US)

Correspondence Address: JOHN H CROZIER, 1934 HUNTINGTON TURNPIKE, TRUMBULL, CT, 06611

(21) Appl. No.: 10/008,023

(22) Filed: Nov. 5, 2001

(51) Int. Cl. C02F 1/46

(52) U.S. Cl. 204/660; 204/666

(57) ABSTRACT

This invention relates to a flexible and conformable apparatus for the purpose of electrostatic removal of very fine particulate from non-conductive fluids. This apparatus is physically conformable and adaptable to existing mechanisms without need for additional separate containment. The two charging electrodes are similarly flexible and conformable. They are housed in separate chambers and wired to a power supply providing positive and negative high voltage. The electrodes impart positive and negative charges to particulate flowing past. The mixing apparatus is connected to the charging apparatus via a turbulence-initiating connector and receives the fluid carrying the charged particles enabling the oppositely charged particles to agglomerate. A downstream porous collection filter connected to the mixing apparatus collects the agglomerated particulate matter.

### BACKGROUND OF THE INVENTION

1. Field of the Invention

The present invention relates to an apparatus for cleaning of fluids, more particularly to means and methods for removing particulate matter from non-conductive fluids. In particular this invention relates to the removing of small particulate matter using electrostatic charge.

2. Description of the Prior Art

A typical non-conductive fluid to be cleaned may be an industrial oil such as used for machinery, as an energy transmitter in hydraulic systems, or as an insulator in electrical transformers and other electrical devices. When lubricating and hydraulic oils become contaminated, the particles of dirt, cause abrasive wear and fatigue on the machine and ultimately machine failure. When electrical oil becomes contaminated it no longer acts effectively as an insulator in a transformer. It is normal practice to change oil when it becomes contaminated.

Lubrication and other oils must be maintained as clean as possible to obtain maximum oil and component life. It is generally recognized that the number of particles larger than five microns in one millimeter of lubricating oil must be kept below 150 to maximize component and lubrication oil life.

Particles five microns and smaller have been conclusively shown to be the major cause of abrasive wear and fatigue that leads to component failure. Adequate regular or continuing fluid purification should extend oil life almost indefinitely, eliminate hazardous waste generation and reduce or eliminate equipment wear due to contaminants in the oil.

It has long been known to remove particulate with mechanical filters, however, these mechanical filters are not effective with particles smaller than 5 microns either because their pore size is too great, or the filter must be large and bulky to avoid an excessive pressure drop within the fluid system.

Electrostatic separation technology has been established as a viable means to better perform cleaning of oils. Electrostatic separation technology is based on passing some of the oil through each of opposite electrostatic fields created by high voltage to electrically charge the particulate matter entrained in the oil. This produces an electrostatic reaction whereupon oppositely charged particles flocculate. The resultant flocculated particles are larger in size than the original constituent particles and are more easily captured. A filter media of a selected pore size may be used to capture and retain these flocculated particles. Thus, particulate matter of submicron size may be extracted from oil, thereby producing oil with a cleanliness level that is unattainable by mechanical filters. The following United States Patents are representative of the prior art for electrostatic fluid filters:

| | | |
|---|---|---|
| 4,594,138 | June 1986 | Thompson |
| 5,332,485 | July 1994 | Thompson |
| 5,571,399 | November 1996 | Allen |
| 5,788,827 | September 1998 | Munson |

While these filters have been designed and are available, most of the devices and apparatus are expensive to construct, bulky or have complicated structure. In addition, the charging and mixing systems are typically rigid canister or housing designs with rigid electrodes used to charge particles as they are swept by. These patents describe fluids that are passed through perforated electrodes that are oppositely polarized by positive and negative charges. The charged particles flocculate and then are collected through a mechanical filter media of various shapes and sizes.

Many of the systems using lubricating oil are compact and do not have available space for a bulky rigid, external cleaning system or space to incorporate rigid canisters or rigid electrodes or mixing chambers. Vehicle lubrication systems where small size and physically conformable systems are required are a primary example. In addition, many application environments are sensitive to size, weight, on-board mobility, time, temperature and cost.

### SUMMARY OF THE INVENTION

It is a principal object of the present invention to provide a means of broadening the application areas for electrostatic particulate removal by providing a flexible physically conformable fluid path for charging and mixing chambers, flexible electrodes and turbulence-initiating connector to enhance flocculation of particles.

It is yet another object of the invention to provide a fluid path for charging and mixing which does not require an additional separate external housing or containment vessel.

It is another object of the invention to provide a physically conformable fluid path, flexible electrode and turbulence initiating connector that are economical to construct.

It is yet another object of the invention to provide a simple economical means of passing high voltage wires from the electrodes inside the charging chambers to the power supply outside, while maintaining the continence of the fluid circuit.

The present invention achieves the above objects by providing a physically conformable fluid system comprising: a fluid pathway with a connector to split the fluid flow of the fluid to form two charging chambers; flexible high voltage electrodes contained within the fluid pathways in the two charging chambers and connected to the power supply to provide a positive and negative electrostatic charge to particles in the fluid; a connector to join the two fluid paths and initiate efficient mixing through turbulence, thereby enabling oppositely charged particles to flocculate; a means for effectively passing the high voltage wires from inside the charging chambers, exiting through the connector walls to the outside power source while maintaining the continence of the fluid circuit; a flexible and physically conformable mixing chamber which is connected to the turbulence-initiating connector to enable oppositely charged particles to flocculate. The flexible and conforming charging and mixing chambers are designed to adequately contain the pressurized fluid without added containment.

### BRIEF DESCRIPTION OF THE DRAWING

FIG. 1 shows a schematic of the flexible and conforming non-conductive fluid purification system.

FIG. 2A shows a physically conformable version where the flexible tubing, comprising the charging chambers and the mixing chamber, and the flexible electrodes, and the connecting turbulence initiating connector, are configured in a spiral.

FIG. 2B shows a cut-away view of a small portion of the flexible tubing that comprises one charging chamber, allowing the flexible electrode and its connection to the high voltage wire to be viewed.

FIG. 3A shows a detailed view of the flexible electrode comprised of four wires wound in alternately reverse lay and progressively larger internal and external diameters so as to permit inserting each coiled wire inside the others.

FIG. 3B shows a cross-sectioned view of FIG. 3A.

FIG. 4 is a Table that describes the wire size and physical make-up of the individual coiled wires.

FIG. 5A shows a side view of the turbulence-initiating connector.

FIG. 5B shows a cross-section of the turbulence-initiating connector configured with the two channels funneling into one and with the high voltage wires exiting from inside the charging chambers to the outside.

FIG. 5C shows an end-view of the exit side of the turbulence-initiating connector.

FIG. 6 is a table showing results of a laboratory test of the present invention.

### DETAILED DESCRIPTION OF THE INVENTION

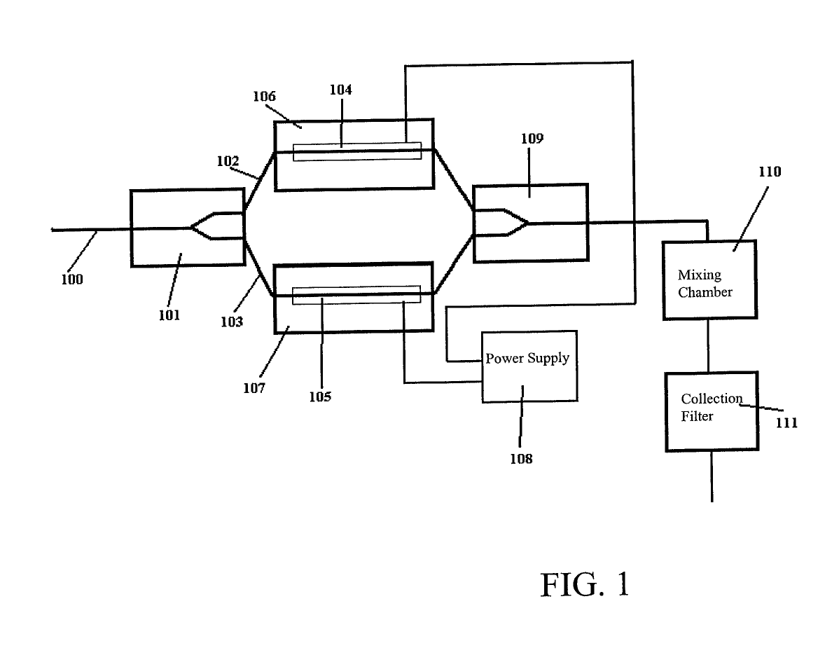

FIG. 1 illustrates a system diagram of the electrostatic filter of the present invention. An oil inlet 100 is connected to a fluid splitter 101 which splits the fluid into two distinct paths 102 and 103. Charging electrodes 104 and 105 are contained within the charging chambers 106 and 107 wherein oil flows past the electrodes. Particulate in the oil passes the electrodes where a net positive charge is impinged on particulate passing electrode 105 and a net negative charge is impinged on particulate passing electrode 104 through the power supplied by power supply 108. The power supply 108 is a source of DC electrical potential, with a voltage in the range of 5000 to 50,000 volts both positive and negative. The two oil paths containing the charged particulate are joined through a turbulence-initiating connector 109. The particulate agglomerates in connector 109 and in the mixing chamber 110 to be collected by a filter in the collection filter 111.

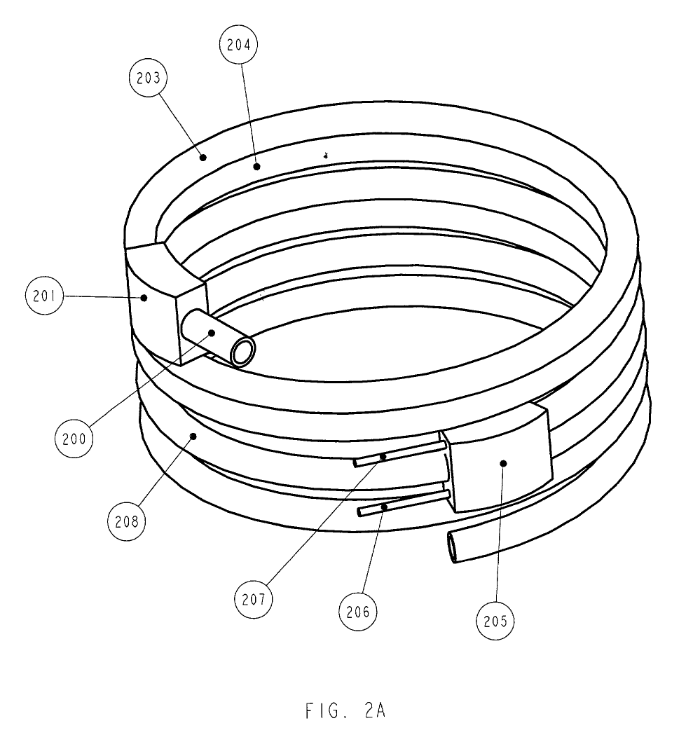

FIG. 2A illustrates a preferred embodiment of the present invention in a spiral configuration. The entering fluid enters through the tube 200 and is split into two paths through the use of a splitter 201. One can also split into multiple pairs of paths. The splitter incorporates two ports to form a double spiral lead whereby two tubes 203 and 204 create two charging chambers for positive and negative charging of the particulate. The splitter in this embodiment is made from a high dielectric strength material, in this case Teflon®, capable of withstanding temperatures up to 260° C. The electrodes 210 and 211 (shown in FIG. 2B) housed in charging chamber tubes 203 and 204, charge the particulate. The turbulence-initiating connector 205 funnels the two charged streams of particulate into the mixing chamber comprised of a tube 208, and provides an egress for the high voltage wires 206 and 207, which are connected to the electrodes 210 and 211, from inside the charging chambers to the outside electrical power source (not shown). The mixing chamber 208 is of sufficient length to give the charged particles a chance to agglomerate. FIG. 2B shows a preferred embodiment of the connection and housing of the electrodes within the charging chambers 203 and 204. High voltage wire 206 is coupled to a multitude of wires coiled in the form of interlaced springs, which form the electrodes 210 using a crimped coupler 301. This same embodiment would be duplicated for chamber 204 and the connection of high-voltage wire 207 to electrode 211. It is important to note that this tubing configuration need not be put in a housing such as a canister or box. The housing for this embodiment is of no consequence and offers tremendous flexibility as to where to physically place or route the charging and mixing chambers.

### The Flexible Charging and Mixing Chambers

In this embodiment, the charging and mixing chambers 203, 204 and 208 are constructed from flexible tubing, ½ inch outside diameter and 3/8 inch inside diameter Teflon® tubing capable of withstanding 600 Volts per mil of wall thickness, at a maximum operating temperature of 400 degrees F. (260° C.). The chamber cross-sectional shape could vary from tubular, and its area could be greater or smaller depending upon pressure, throughput, geometric conformance or other requirements of the specific application. This tubing has a durometer hardness of 55D and a minimum bending radius of 4 inches. This fluorocarbon material will withstand almost all known chemical environments, including vegetable oils, lubricating oils, cutting oils, hydraulic oils, diesel fuels, and others. The described embodiment is not limited to a spiral design and could be easily incorporated into a design requiring the charging and mixing chambers to be straight or “S” shaped or other configurations as long as the 4 inch minimum bending radius is not violated. The length of the charging and mixing chambers 203, 204 and 208 are generally related to the rate of flow of fluids through the particular fluid system.

### The Flexible Electrodes

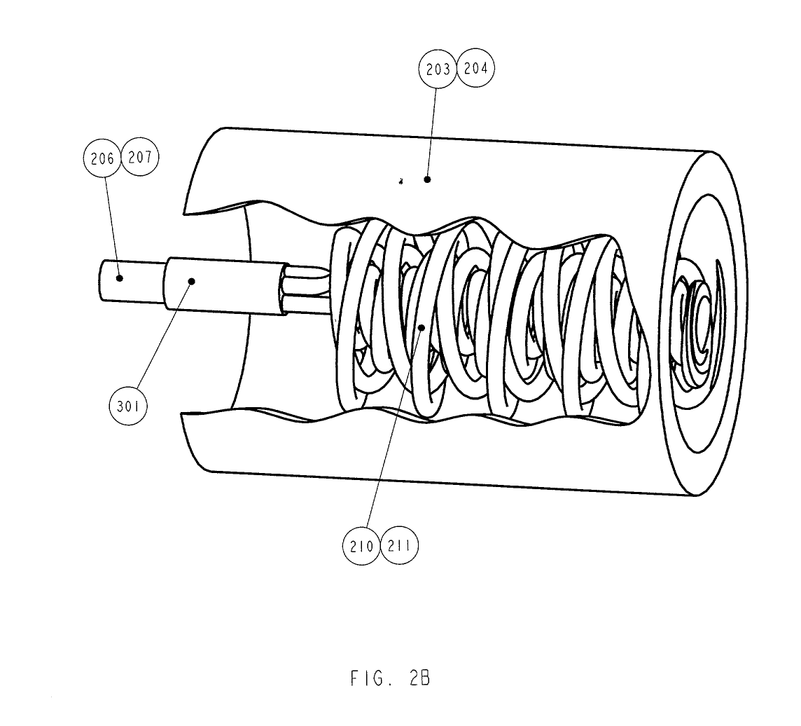

FIG. 3A shows the layout of the flexible electrode. The flexible high voltage electrode is comprised of wires 401, 402, 403 and 404 coiled in the form of a springs, with wire size, spring diameter, pitch and direction of lay that permits inserting one spring inside another as shown in FIG. 3B. The number of inter-laced springs, their materials, and their lengths are determined by the application. In this embodiment, the material is stainless steel. Other appropriate materials are those that are electrical conductors with an affinity for wetting, and the ability to retain their spring shape and flexibility. In certain cases, it may be desirable to electroplate or otherwise coat the springs with materials that improve their ability to impart a charge.

The interlaced springs are designed to provide a labyrinth through which the dirty non-conducting fluid flows while destroying laminar flow. As the fluid traverses the labyrinth, it encounters the springs 401, 402, 403 and 404 and is forced around the wire at an accelerated rate. The particulates that cannot negotiate the direction change are propelled into the high voltage electrode thereby picking up a charge. Those particles that manage to go around the first barrier are also accelerated and centrifugally directed towards and collide with the next wire, and so on, causing more and more dirt particles to be effectively and efficiently charged along the length of the electrode.

As the manufacturing technology of spring winding is highly advanced, the resulting interlaced, flexible, highly efficient high voltage electrode is significantly low in cost, easy to design, and readily procurable. The interlaced springs are easily assembled, and allow easy bending to conform to its geometric design. In this embodiment, the electrodes are laid in tubing configuring the electrode in a spiral pattern. The electrode may be laid straight or in an “S” configuration or other configurations as well.

In this embodiment, the electrode is comprised of four interlaced springs, 401, 402, 403 and 404. The spring material is stainless steel, with equal wire diameters of 0.025 inches. Wire 401 is wound in a right hand lay with a pitch of 30.3 coils per inch. This results in an inside diameter of 0.075 inches and an outside diameter of 0.125 inches. Wire 402 is wound in a left hand lay with a pitch of 19.2 coils per inch, providing an inside diameter of 0.138 inches and outside diameter of 0.188 inches. Coiled wire 401 can be readily inserted into coiled wire 402 leaving a space of 0.0065 inches per side between the two, and more varied labyrinth because of the oppositely wound lays and different pitches as shown in FIG. 3B. This continues in like fashion for wires 403 and 404, where the outside diameter of wound coil 404 of 0.313 inches fits into the Teflon® tubing with an inside diameter of 0.375 inches. In its coiled spring configuration, the electrode is able to flex and conform to any shape the flexible charging chamber assumes.

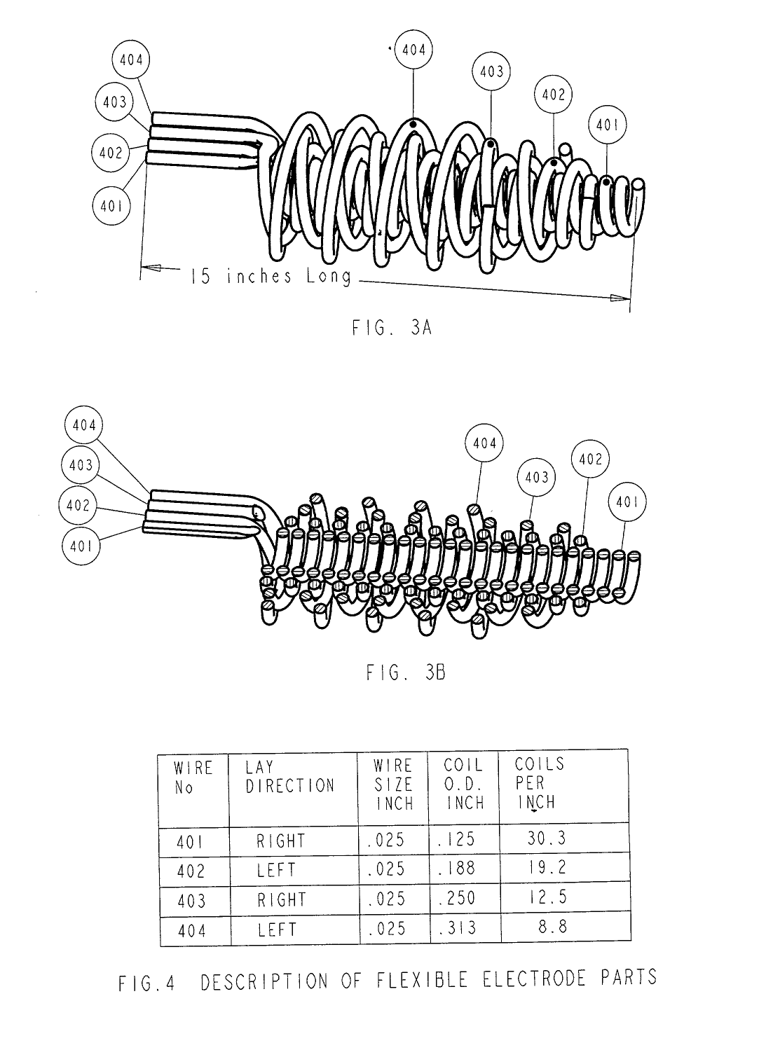

FIG. 4 indicates the lay, wire size, coil OD and coils-per-inch for this embodiment. The number of coils, length, wire size and coil OD can vary depending on the cleaning application. A larger capacity system may require more coils and longer length.

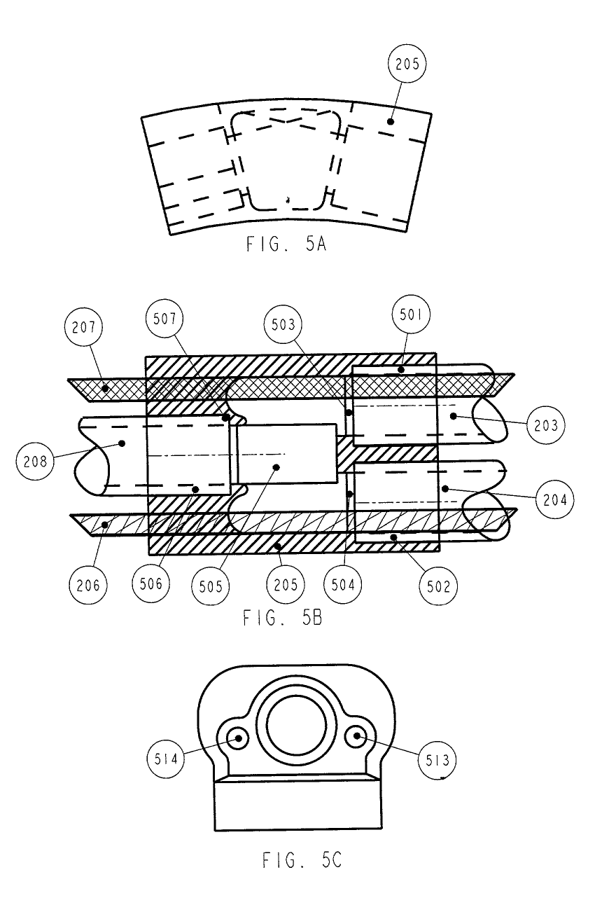

FIG. 5A is a side view of the turbulence-initiating connector 205. This connector is designed to collect the fluids from the two charging chambers 203 and 204 (FIG. 1), initiate a swirling turbulent action and funnel the two swirling streams into the single mixing chamber 208 (FIG. 1). This connector also allows egress for the high voltage wires from inside the two charging chambers to the power supply outside while maintaining the continence of the fluid circuit. FIG. 5B shows a cross-sectional view of the turbulence-initiating connector 205. For this embodiment in FIG. 5B, inlet ports 203 and 204 containing oppositely charged particles mate with the turbulence-initiating connector 205 at entrance ports 501 and 502. Entrances to the internal swirling chamber 505 is achieved through port openings 503 and 504. The resultant mixed fluid exits through port 506 and subsequently to a main mixing chamber, tube 208. FIG. 5C shows an end view of the turbulence-initiating connector 205. The connector incorporates two small channels 513 and 514 passing through the wall of the connector through which high voltage wires 206 and 207 can intersect and pass through the swirling chamber 505 into ports 501 and 502 and be connected to the flexible electrodes 210 and 211 (FIG. 2A). The turbulence-initiating connector serves to reduce the length of the main mixing chamber and the time required for the opposite charges to encounter each other and agglomerate.

In this embodiment, the turbulence-initiating connector 205 is made of Teflon®. The entrance ports 501 and 502, are narrowed at the entrance 503 and 504 to the small internal swirling chamber 505 of the connector in order to speed up the entrance velocity of the two streams of fluid and to create a stop for the tubing so as not to encroach on the internal swirling chamber. The exit port 506 is likewise reduced so as to create a stop 507 for the tubing, to create an even larger back pressure in the internal swirling chamber than already present, and to increase the turbulent velocity down the flexible main mixing chamber 208. The turbulence-initiating connector 205 is curved in this embodiment to replicate the conformance of this particular spiral configuration, but could easily be rectangular, cylindrical, or of a complex shape that could be used to conform to a particular locating geometry. The entrance and exit ports have a 2:1 area (from 0.221 to 0.110 square inches) creating a large back-pressure which in turn initiates a violent turbulent swirling as the fluid and particulate merge, collide, and then exit down the main flexible mixing chamber 208 at a high velocity. This high velocity swirling turbulence down the main mixing chamber provides many more occasions for the oppositely charged particulate to meet and agglomerate in a minimum of distance.

The subsequent flocculated particles and fluid pass from the mixing chamber 208 to a collection filter (not shown). The collection filter can be widely varied as needed for a particular application. The collection filter is typically constructed of reticulated foam or other suitable material having communicating pores throughout. The collection filter can be, but need not be incorporated into the same tube as the mixing chamber 208 and can itself be physically conformable.

The high voltage wires 206 and 207 are routed inside charging chamber tubes 511 and 512 and into charging tubes 203 and 204. The connector provides easy access to the outside by passing through ports 513 and 514 that are sized to constrain the high voltage wires and provide an easy means of bonding them in place with epoxy or other non-conductive adhesive.

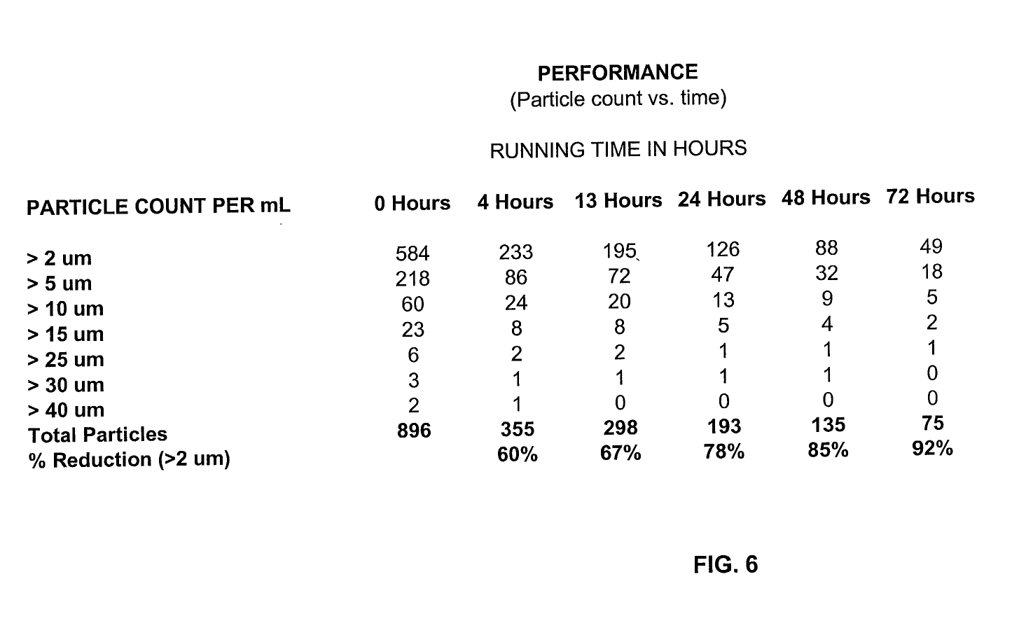

FIG. 6 shows data from a laboratory test using the charging and mixing system of the present invention. FIG. 6 is a table of time versus particle count versus particle size (as used to clean transformer oil, a particularly difficult medium to clean). In a 72 hour test, large size particulate greater than 30 microns were eliminated and smaller particulate greater than 2 microns was dramatically reduced by 92%.

I claim:

1) A flexible and physically conformable electrostatic cleaning system for removing particulate matter from non-conductive fluid. Such system comprised of:
a) Two flexible and physically conformable charging chambers housing two charging electrodes, connected to a power supply that provides positive and negative electrostatic charging potentials, for the purpose of charging said particulate matter.
b) A mixing chamber connected to the two charging chambers to receive fluid and to maintain high velocity turbulence to enhance agglomeration of oppositely charged particles.
c) A connector that funnels the fluids from the two charging chambers to the mixing chamber, initiates turbulent high velocity swirling and agglomeration, and passes the high voltage wires through its walls to the external power source.

2) An apparatus as defined in claim 1 wherein:
a) The charging and mixing chambers and the turbulence-initiating connector do not require additional separate housings or containers.

3) An apparatus as defined in claim 1 wherein:
a) Flexible and physically conformable charging electrodes are formed by wires coiled in the form of a spring with pitch, diameter and direction of lay to permit insertion of one spring inside another.
b) Flexible and physically conformable charging electrodes are laid in flexible non-conductive material of high dielectric strength and temperature resistance to allow a flexible and physically conformable charging chamber
c) Said charging chamber made from Teflon® tubing or other high dielectric strength material capable of providing conforming channels or chambers.

4) An apparatus as defined in claim 1 wherein:
a) A turbulence-initiating connector is used to combine two charged fluid streams and initiate a turbulent swirling action to assist flocculation of charged particles.
b) Said turbulence-initiating connector is made of Teflon® high dielectric strength material.
c) Said turbulence-initiating connector has entrance and exit ports that increase fluid velocity by reduction of diameter to create additional back pressure and enhance mixing.
d) Said turbulence-initiating connector contains conduits to allow power wires to pass through the connector walls to the flexible electrodes, while maintaining the continence of the fluid circuit.
e) Said turbulence-initiating connector can be machined or molded to take on a variety of exterior shapes to match the needs of the available space.
f) Said mixing chamber is comprised of a high dielectric strength material with a temperature rating of 260° C. to allow a flexible and physically conformable charging chamber.
g) Said mixing chamber is made from Teflon® tubing or other high dielectric strength material capable of providing physically conformable channels or chambers.
